(19) United States
(12) Patent Application Publication
(10) Pub. No.: US 2010/0332229 A1
(43) Pub. Date: Dec. 30, 2010

(54) APPARATUS CONTROL BASED ON VISUAL LIP SHARE RECOGNITION

(75) Inventors: Kazumi AOYAMA, Saitama (JP); Kohtaro SABE, Tokyo (JP); Masato ITO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/815,478

(22) Filed: Jun. 15, 2010

(30) Foreign Application Priority Data
Jun. 30, 2009 (JP) 2009-154923
Jun. 30, 2009 (JP) 2009-154924

(51) Int. Cl. G10L 15/00; G06K 9/46

(52) U.S. Cl. 704/251; 382/195; 704/E15.042

(57) ABSTRACT

An information processing apparatus that includes an image acquisition unit to acquire a temporal sequence of frames of image data, a detecting unit to detect a lip area and a lip image from each of the frames of the image data, a recognition unit to recognize a word based on the detected lip images of the lip areas, and a controller to control an operation at the information processing apparatus based on the word recognized by the recognition unit.

### CROSS-REFERENCE TO RELATED APPLICATIONS

This application claims the benefit of priority under 35 U.S.C. §119 from Japanese Patent Application Nos. 2009-154924, filed Jun. 30, 2009 and 2009-154923, filed Jun. 30, 2009, the entire contents of each are incorporated herein by reference.

### BACKGROUND OF THE INVENTION

1. Field of the Invention

The present invention relates to an information processing apparatus, an information processing method and a program, and particularly to an information processing apparatus, an information processing method and a program that enable the recognition of utterance content of a speaker based on a moving image obtained by imaging the speaker, that is, the realization of the lip-reading technique.

2. Description of the Related Art

The research of a technique in which movements in a lip area of a speaker as a subject are detected in a moving image by using an image recognition process and the utterance content of the speaker is recognized based on the detection result (hereinafter, referred to as a lip-reading technique) has been existing since the late 1980s.

The lip-reading technique based on such an image recognition process has advantages in that the technique does not affected by environmental noises and can respond to a case where a plurality of subjects utters at the same time, in comparison to a voice recognition technique for recognizing utterance content based on voices.

However, the lip-reading technique in the present state has not been able to acquire a high recognition capability for unspecified speakers in comparison to the voice recognition technique. For that reason, the current lip-reading technique is being studied in the form of

Audio Visual Speech Recognition (AVSR) in which the lip-reading technique plays a supplementary role for the voice recognition technique under a noisy environment. In other words, with the AVSR, the utterance content is inferred based on variations in voices and in the shape of lips.

There are various methods for extracting feature amounts of the shape of lips from images of a lip area in related art.

For example, “Recent Advances in the Automatic Recognition of Audiovisual Speech” written by G. Potamianos, et al. for Proceedings of the IEEE, Vol. 91, No. 9, September, 2003 discloses a method of using geometric information such as a horizontal-vertical ratio of lips by identifying the position of the lips, a method of modeling time series signals of an image by performing a discrete Fourier transforming process to the image in a block shape, a method of performing a block discrete cosine transforming process to an image in order to classify feature amounts obtained from the result of the process into any one of a plurality of mouth shapes, and the like.

“Lip-reading by Optical Flow” written by K. Mase and A. Pentalnd for the Technical Report of the Institute of Television Engineers of Japan, Vol. 13, No. 44, pp. 7-12, 1989 discloses a method of clipping an image of a lip area and using an optical flow. “Audio-visual Large Vocabulary Continuous Speech Recognition based on Feature Integration” written by Ishikawa, et al. for the National Conference of the Forum on Information Technology in 2002, pp. 203-204 discloses a method in which an image subjected to a main component analyzing process is made into a low-dimensional image to be used as a feature amount.

Furthermore, there are other methods including a method of detecting the shapes of lips with markings by attaching a luminous tape on the mouth of a speaker and specifying phonemes by expressing the shapes of lips with Fourier descriptors (for example, refer to Japanese Unexamined Patent Application Publication No. 2008-146268), a method of specifying a vowel by measuring a myoelectric potential of a lip area (for example, refer to Japanese Unexamined Patent Application Publication No. 2008-233438), and the like.

Moreover, “Recent Advances in the Automatic Recognition of Audiovisual Speech” written by G. Potamianos, et al. for Proceedings of the IEEE, Vol. 91, No. 9, September, 2003, Japanese Unexamined Patent Application Publication No. 2008-233438, Japanese Unexamined Patent Application Publication No. 2008-310382, and the like include a method of recognizing utterance by classifying the shapes of lips into several kinds (for example, refer to “Recent Advances in the Automatic Recognition of Audiovisual Speech” written by G. Potamianos, et al. for Proceedings of the IEEE, Vol. 91, No. 9, September, 2003, Japanese Unexamined Patent Application Publication No. 2008-233438, and Japanese Unexamined Patent Application Publication No. 2008-310382).

### SUMMARY OF THE INVENTION

As described above, in the related art, feature amounts of the shapes of lips have been obtained by various methods, but there are problems in that separation according to the shapes of the lips is difficult within the space of the feature amounts, in addition that lip areas have extremely significant differences among individuals, and the recognition of utterance from an unspecified speaker is challenging.

Moreover, the methods of using the markings and measuring the myoelectric potentials mentioned above are not able to be deemed appropriate when it comes to taking the practical lip-reading technique into consideration.

Furthermore, the method of recognizing utterance by classifying the shapes of the lips into several kinds merely classifies a state of lips uttering a vowel and a closed state of the lips, and is not able to distinguish and identify words, for example “hanashi” and “tawashi”, which have the same vowels and different consonants.

The present invention took into consideration above circumstances and it is desirable to provide recognition performance with high accuracy for the utterance content from an unspecified speaker in the lip-reading technique using moving images.

Particularly, the present invention is directed to an information processing apparatus that includes an image acquisition that acquires a temporal sequence of frames of image data, a detecting unit that detects a lip area and a lip image from each of the frames of the image data, a recognition unit that recognizes a word based on the detected lip images of the lip areas, and a controller that controls an operation at the information processing apparatus based on the word recognized by the recognition unit.

The information processing apparatus may be a digital still camera. In this case the image acquisition unit is an imaging device of the digital still camera, and the controller commands the imaging device of the digital still camera to capture a still image when the recognition unit recognizes a predetermined word.

The information processing apparatus may also include a face area detecting unit that detects a plurality of faces in the sequence of frames of image data, and the recognition unit recognizes a particular face from among a plurality of faces based on stored facial recognition data and recognizes a word based on detected lip images of lip areas of the particular face.

The information processing apparatus may also include a face area detecting unit that detects a plurality of faces in the sequence of frames of image data, and the recognition unit recognizes a word based on detected lip images of lip areas of any one of the plurality of faces.

The information processing apparatus may also include a face area detecting unit that detects a plurality of faces in the sequence of frames of image data, and the recognition unit recognizes a word based on detected lip images of lip areas of a subset of the plurality of faces.

The information processing apparatus may also include a registration unit that registers a word causing the controller to control an operation of the information processing apparatus when the word is recognized by the recognition unit.

The information processing apparatus may also include a memory that stores a plurality of visemes, each associated with a particular phoneme, and the recognition unit recognizes a word by comparing the detected lip images of the lip areas to the plurality of visemes stored in the memory.

The information processing apparatus may also include a learning function that includes an image separating unit configured to receive an utterance moving image with voice, separate the utterance moving image with voice into an utterance moving image and an utterance voice, and output the utterance moving image and the utterance voice; a face area detecting unit configured to receive the utterance moving image from the image separating unit, split the utterance moving image into frames, detect a face area from each of the frames, and output position information of the detected face area together with one frame of the utterance moving image; a lip area detecting unit configured to receive the position information of the detected face area together with the one frame of the utterance moving image from the face area detecting unit, detect a lip area from the face area of the one frame, and output the position information of the lip area together with the one frame of the utterance moving image; a lip image generating unit configured to receive the position information of the lip area from the lip area detecting unit together with the one frame of the utterance moving image, perform rotation correction for the one frame of the utterance moving image, generate a lip image, and output the lip image to a viseme label adding unit; a phoneme label assigning unit configured to receive the utterance voice from the image separating unit, assign a phoneme label indicating a phoneme to the utterance voice, and output the label; a viseme label converting unit configured to receive the label from the phoneme label assigning unit, convert the phoneme label assigned to the utterance voice for learning into a viseme label indicating the shape of the lip during uttering, and output the viseme label; a viseme label adding unit configured to receive the lip image output from the lip image generating unit and the viseme label output from the viseme label converting unit, add the viseme label to the lip image, and output the lip image added with the viseme label; a learning sample storing unit configured to receive and store the lip image added with the viseme label from the viseme label adding unit, wherein the recognition unit is configured to recognize a word by comparing the detected position of the lip areas from each of the frames of the image data to the data stored by the learning sample storing unit.

### BRIEF DESCRIPTION OF THE DRAWINGS

FIG. 1 is a block diagram illustrating an example of a composition of an utterance recognition device to which the present invention is applied;

FIGS. 2A to 2C are diagrams illustrating examples of a face image, a lip area, and a lip image;

FIG. 3 is a diagram illustrating an example of a conversion table for converting phoneme labels to viseme labels;

FIG. 4 is a diagram illustrating an example of learning samples;

FIG. 5 is a diagram illustrating an example of a time series feature amount;

FIG. 6 is a flowchart explaining an utterance recognition process;

FIG. 7 is a flowchart explaining a learning process;

FIG. 8 is a flowchart explaining a process of an utterance moving image for learning;

FIG. 9 is a flowchart explaining a process of an utterance voice for learning;

FIG. 10 is a flowchart explaining an AdaBoost ECOC learning process;

FIG. 11 is a flowchart explaining a learning process of a binary classification weak classifier;

FIG. 12 is a flowchart explaining a registration process;

FIG. 13 is a flowchart explaining a K-dimensional score vector calculation process;

FIG. 14 is a flowchart explaining a recognition process;

FIG. 15 is a diagram illustrating an example of utterance words for registration;

FIG. 16 is a diagram illustrating a recognition capability;

FIG. 17 is a block diagram illustrating an example of a composition of a digital still camera to which the present invention is applied;

FIG. 18 is a block diagram illustrating an example of a composition of an automatic shutter controlling unit;

FIG. 19 is a flowchart explaining an automatic shutter registration process;

FIG. 20 is a flowchart explaining an automatic shutter execution process; and

FIG. 21 is a diagram illustrating an example of a composition of a computer.

### DESCRIPTION OF THE PREFERRED EMBODIMENTS

Hereinafter, exemplary embodiments for performing the present invention (hereinafter, referred to an embodiment) will be described in detail with reference to accompanying drawings. Furthermore, the description will be provided in the following order.

1. First Embodiment

2. Second Embodiment

### 1. First Embodiment

### Example of Composition of Utterance Recognition Device

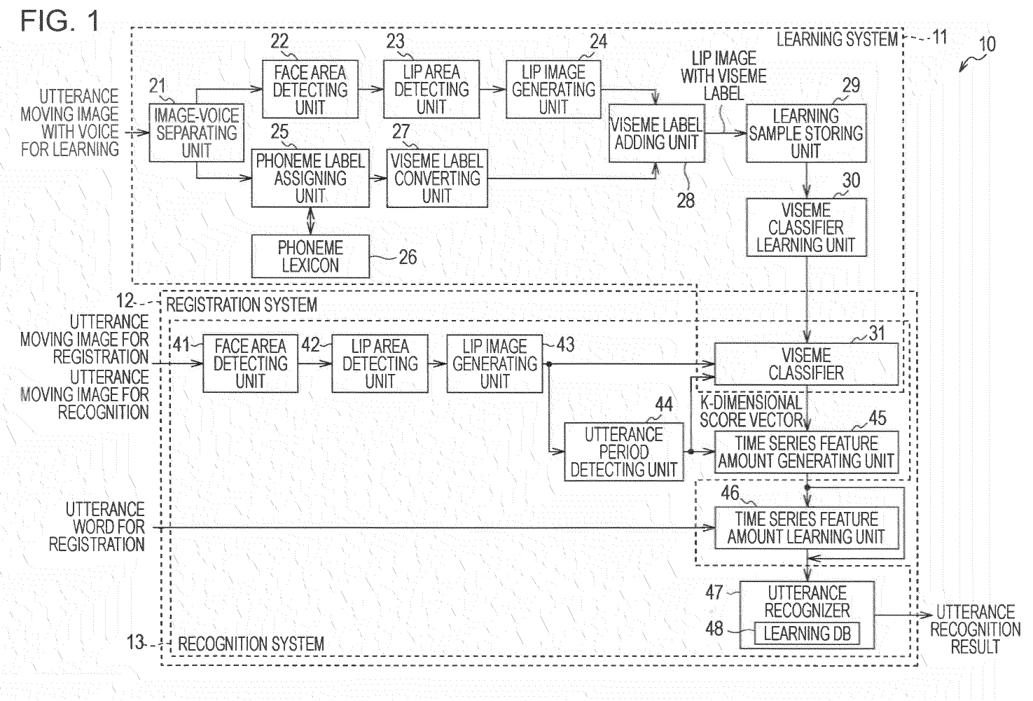

FIG. 1 is a diagram illustrating an example of a composition of an utterance recognition device 10 for a first embodiment. The utterance recognition device 10 recognizes the utterance content of a speaker based on a moving image obtained by video-capturing the speaker as a subject.

The utterance recognition device 10 includes a learning system 11 for executing a learning process, a registration system 12 for carrying out a registration process, and a recognition system 13 for carrying out a recognition process.

The learning system 11 includes an image-voice separating unit 21, a face area detecting unit 22, a lip area detecting unit 23, a lip image generating unit 24, a phoneme label assigning unit 25, a phoneme lexicon 26, a viseme label converting unit 27, a viseme label adding unit 28, a learning sample storing unit 29, a viseme classifier learning unit 30, and a viseme classifier 31.

The registration system 12 includes a viseme classifier 31, a face area detecting unit 41, a lip area detecting unit 42, a lip image generating unit 43, an utterance period detecting unit 44, a time series feature amount generating unit 45, a time series feature amount learning unit 46, and an utterance recognizer 47.

The recognition system 13 includes the viseme classifier 31, the face area detecting unit 41, the lip area detecting unit 42, the lip image generating unit 43, the utterance period detecting unit 44, the time series feature amount generating unit 45, and the utterance recognizer 47.

In other words, the viseme classifier 31 belongs to the learning system 11, the registration system 12 and the recognition system 13 in an overlapping manner, and a system set by excluding the time series feature amount learning unit 46 from the registration system 12 is the recognition system 13.

The image-voice separating unit 21 receives the input of an moving image with voice (hereinafter, referred to as utterance moving image with voice for learning) obtained by video-capturing a speaker who speaks an arbitrary word, and separates the input image into an utterance moving image for learning and an utterance voice for learning. The separated utterance moving image for learning is input to the face area detecting unit 22, and the separated utterance voice for learning is input to the phoneme label assigning unit 25.

Furthermore, the utterance moving image with voice for learning may be prepared by video-capturing for the learning, and may use, for example, content such as television programs, or the like.

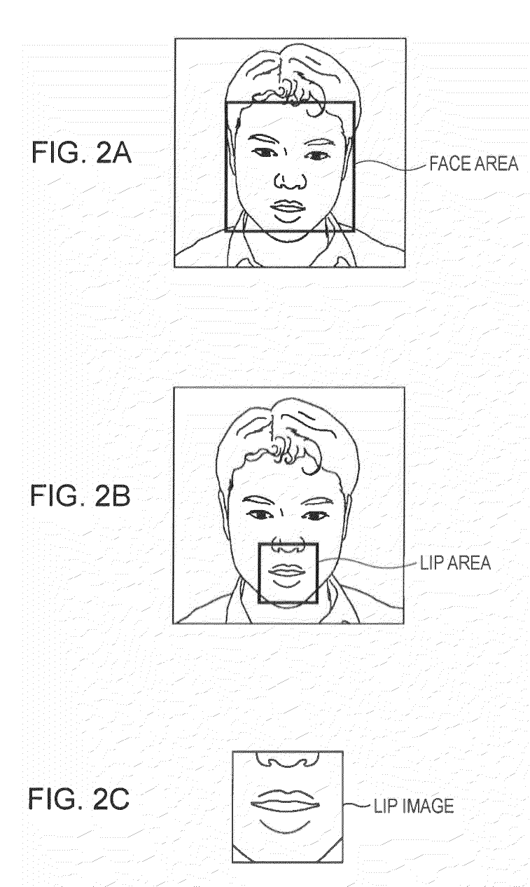

The face area detecting unit 22 splits the utterance moving image for learning into frames, detects a face area including the face of a person in each frame as shown in FIG. 2A, and outputs position information of the face area of each frame to the lip area detecting unit 23 together with the utterance moving image for learning.

The lip area detecting unit 23 detects a lip area including the edge points of the corners of the mouth at the lips from the face area of each frame of the utterance moving image for learning as shown in FIG. 2B, and outputs position information of the lip area of each frame to the lip image generating unit 24 together with the utterance moving image for learning.

Furthermore, for a method for detecting a face area and a lip area, any existing technique such as a technique disclosed in, for example, Japanese Unexamined Patent Application Publication No. 2005-284348, Japanese Unexamined Patent Application Publication No. 2009-49489, or the like can be applied.

The lip image generating unit 24 appropriately performs rotation correction for each frame of the utterance moving image for learning so that lines connecting the edge points of the corners of the mouth at the lips are horizontal. Moreover, the lip image generating unit 24 extracts the lip area from each frame after the rotation correction, and generates a lip image by resizing the extracted lip area to an image size (for example, 32×32 pixels) that has been determined in advance, as shown in FIG. 2C. The lip image for each frame generated in that manner is supplied to a viseme label adding unit 28.

The phoneme label assigning unit 25 assigns a phoneme label indicating a phoneme for an utterance voice for learning with reference to the phoneme lexicon 26, and outputs the phoneme label to the viseme label converting unit 27. For a method of assigning a phoneme label, a method in the field of voice recognition research called automatic phoneme labeling can be applied.

The viseme label converting unit 27 converts the phoneme label assigned to the utterance voice for learning into a viseme label indicating the shape of the lips during uttering, and outputs the converted label to the viseme label adding unit 28. Furthermore, a conversion table that has been prepared in advance is used for the conversion.

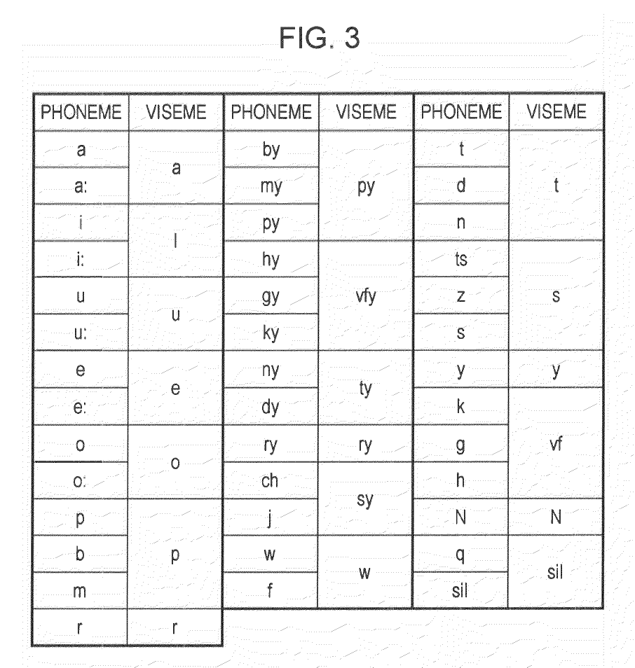

FIG. 3 shows an example of a conversion table for converting a phoneme label into a viseme label. When the conversion table in the drawing is used, phoneme labels classified into 40 kinds are converted into viseme label classified into 19 kinds. For example, phoneme labels [a] and [a:] are converted into a viseme label [a]. In addition, for example, phoneme labels [by], [my], and [py] are converted into a viseme label [py]. Furthermore, the conversion table is not limited to the one shown in FIG. 3, and any conversion table may be used.

The viseme label adding unit 28 uses the viseme label assigned to the utterance voice input from the viseme label converting unit 27 to add to the lip image for each frame of the utterance moving image for learning input from the lip image generating unit 24, and outputs the lip image added with the viseme label to the learning sample storing unit 29.

The learning sample storing unit 29 stores a plurality of lip images with added viseme labels (hereinafter, referred to as lip images with viseme labels) as learning samples.

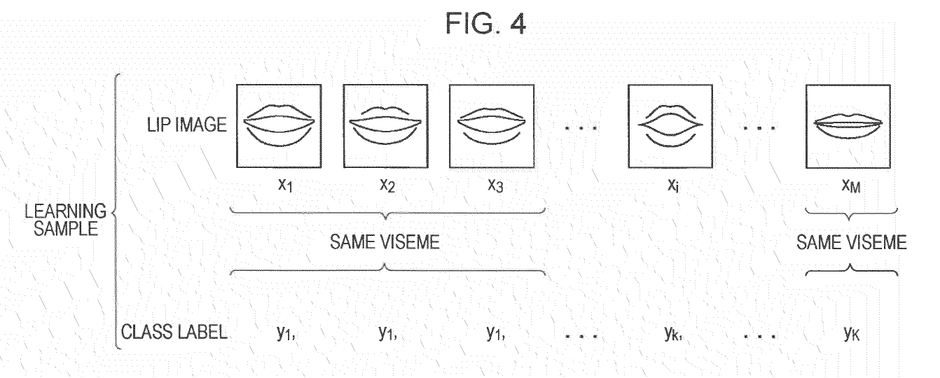

More specifically, as shown in FIG. 4, the M number of learning samples (xi, yk) in a state that a class label yk (k=1, 2, . . . , K) corresponding to a viseme label is assigned to M pieces of lip image xi (i=1, 2, . . . , M). Furthermore, in the present case, the number K of the kinds of the class labels is 19.

The viseme classifier learning unit 30 obtains an image feature amount from the lip images with viseme labels as a plurality of learning samples stored in the learning sample storing unit 29, learns a plurality of weak classifiers by the AdaBoost ECOC, and generates the viseme classifier 31 formed of the plurality of weak classifiers.

As an image feature amount of a lip image, for example, a Pixel Difference Feature (PixDif Feature) that the inventors of the present invention suggest can be used.

Furthermore, the PixDif Feature (Pixel Difference Feature) is disclosed in “Learning of a Real-time Arbitrary Posture and Face Detector using Pixel Difference Features” written by Sabe and Hidai for the Proceedings of the 10th Symposium on Sensing via Image Information, pp. 547-552, 2004, Japanese Unexamined Patent Application Publication No. 2005-157679, and the like.

The pixel difference feature can be obtained by calculating the difference in pixel values (luminance values) I1 and I2 (I1−I2) of two pixels on an image (a lip image in this case). In a binary classification weak classifier h(x) corresponding to each combination of the two pixels, as shown in Formula (1) shown below, true (+1) or false (−1) is determined by the pixel difference feature I1−I2 and a threshold value Th.

h(x)=−1, if I1−I2 Th

h(x)=+1, if I1−I2>Th (1)

For example, when the size of the lip image is 32×32 pixels, a pixel difference feature of at set of 1024×1023 pixels is obtained. Those combinations of plural sets of the two pixels and the threshold value Th are parameters of each binary classification weak classifier, and the optimal one among the parameters is selected by boosting learning.

The viseme classifier 31 calculates a K-dimensional score vector corresponding to the lip image input from the lip image generating unit 43 during the utterance period informed by the utterance period detecting unit 44 and outputs the result to the time series feature amount generating unit 45.

Here, the K-dimensional score vector is an index indicating which of K (K=19 in this case) kinds of visemes the input lip image corresponds to, and formed with a K-dimensional score representing a probability of corresponding to K kinds of each viseme.

The face area detecting unit 41, the lip area detecting unit 42, and the lip image generating unit 43 that belongs to the registration system 12 and the recognition system 13 are the same ones of the face area detecting unit 22, the lip area detecting unit 23, and the lip image generating unit 24 that belongs to the learning system 11 described above.

Furthermore, the registration system 12 is input with a plurality of registration data obtained by combining the utterance content (utterance words for registration) that has been determined and a moving image produced by video-capturing a speaker uttering the content (hereinafter, referred to as an utterance moving image for registration).

In addition, the recognition system 13 is input with the moving image produced by video-capturing the speaker uttering the utterance content that is a target to be recognized (hereinafter, referred to an utterance moving image for recognition).

In other words, during the registration process, the face area detecting unit 41 splits an utterance moving image for registration into frames, detects a face area for each frame, and outputs position information of the face area in each frame to the lip area detecting unit 42 together with the utterance moving image for registration.

The lip area detecting unit 42 detects the lip area from the face area in each frame of the utterance moving image for registration, and outputs position information of the lip area in each frame to the lip image generating unit 43 together with the utterance moving image for registration.

The lip image generating unit 43 extracts the lip area from each frame after appropriately performing rotation correction for each frame of the utterance moving image for registration, generates a lip image by resizing, and outputs the image to the viseme classifier 31 and the utterance period detecting unit 44.

In addition, during a recognition process, the face area detecting unit 41 splits an utterance moving image for recognition (a moving image in which the utterance content from the speaker is unclear) into frames, detects the face area for each frame, and outputs position information of the face area in each frame to the lip area detecting unit 42 together with the utterance moving image for recognition.

The lip area detecting unit 42 detects the lip area from the face area in each frame of the utterance moving image for recognition, and outputs position information of the lip area in each frame to the lip image generating unit 43 together with the utterance moving image for recognition.

The lip image generating unit 43 extracts the lip area from each frame after appropriately performing rotation correction for each frame of the utterance moving image for recognition, generates a lip image by resizing, and outputs the image to the viseme classifier 31 and the utterance period detecting unit 44.

The utterance period detecting unit 44 specifies a period in which the speaker makes an utterance (hereinafter, referred to as an utterance period) based on the lip image in each frame of the utterance moving image for registration and the utterance moving image for recognition input from the lip image generating unit 43, and informs the viseme classifier 31 and the time series feature amount generating unit 45 of whether or not the lip image in each frame corresponds with the utterance period.

The time series feature amount generating unit 45 generates a time series feature amount by arranging the K-dimensional score vector input from the viseme classifier 31 in time series during the utterance period informed from the utterance period detecting unit 44.

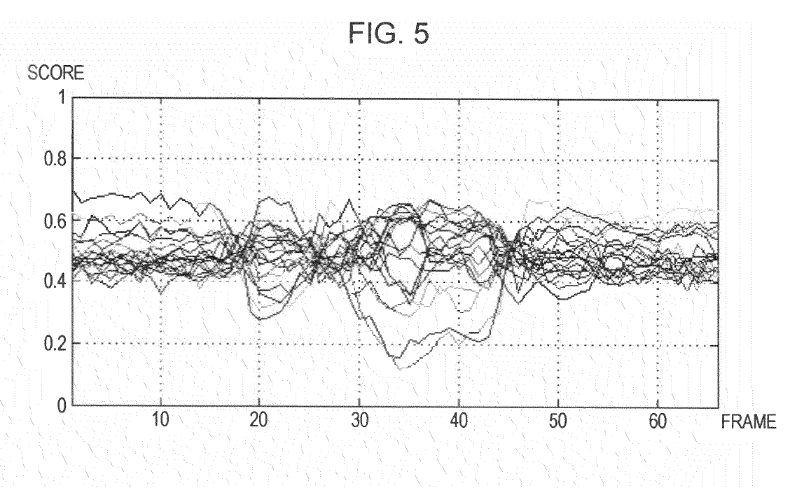

FIG. 5 shows times series feature amounts corresponding to an utterance period when a speaker makes the utterance “interesting”. In other words, if the utterance period is one second and the frame rate is 60 frames/sec, time series feature amounts including the score of 60K are generated. The generated times series feature amount is output to the time series feature amount learning unit 46 during the registration process and output to the utterance recognizer 47 during the recognition process.

The time series feature amount learning unit 46 performs modeling using the Hidden Markov Model (HMM) for the time series feature amount input from the time series feature amount generating unit 45 by associating the amount with the utterance word for registration (utterance content by the speaker in the utterance moving image for registration) input during the registration process. Furthermore, the technique of the modeling is not limited to the HMM, and any technique that can be used for modeling a time series feature amount may be possible. The modeled time series feature amount is stored in a learning database 48 built in the utterance recognizer 47.

The utterance recognizer 47 specifies a time series feature amount that is the most similar one to time series feature amount input from the time series feature amount generating unit 45 among the models of time series feather amounts stored in the learning database 48 during the recognition process. Moreover, the utterance recognizer 47 outputs the utterance word for registration in association with the specified model as a result of utterance recognition corresponding to the utterance moving image for recognition.

### Description on Operation

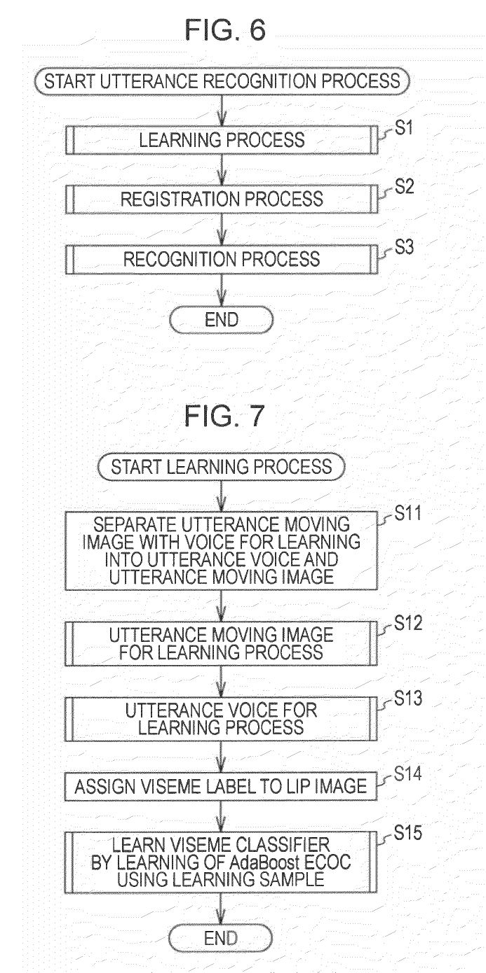

FIG. 6 is a flowchart explaining the operation of the utterance recognition device 10.

In Step S1, the learning system 11 of the utterance recognition device 10 generates the viseme classifier 31 by executing a learning process.

In Step S2, the registration system 12 of the utterance recognition device 10 generates time series feature amounts corresponding to the utterance moving image for registration by executing a registration process, performs modeling using the HMM, and registers models of the time series feature amounts by associating the amounts with utterance words for registration in the learning database 48.

In Step S3, the recognition system 13 of the utterance recognition device 10 recognizes the utterance content by a speaker in an utterance moving image for recognition by executing a recognition process.

Hereinafter, the processes from Step S1 to Step S3 described above will be described in detail.

### Details of Learning Process

FIG. 7 is a flowchart explaining the learning process of Step S1 in detail.

In Step S11, an utterance moving image with voice for learning is input to the image-voice separating unit 21. The image-voice separating unit 21 separates the utterance moving image with voice for learning into an utterance moving image for learning and an utterance voice for learning, and outputs the utterance moving image for learning to the face area detecting unit 22 and outputs the utterance voice for learning to the phoneme label assigning unit 25.

In Step S12, a process of the utterance moving image for learning is performed. In Step S13, a process of the utterance voice for learning is performed. Actually, the Step S12 and the Step S13 are simultaneously performed in tandem with each other. In addition, the output of the processed utterance moving image for learning (lip image) and the output of the processed utterance voice for learning corresponding thereto (utterance voice for learning attached with a viseme label) are simultaneously supplied to the viseme label adding unit 28.

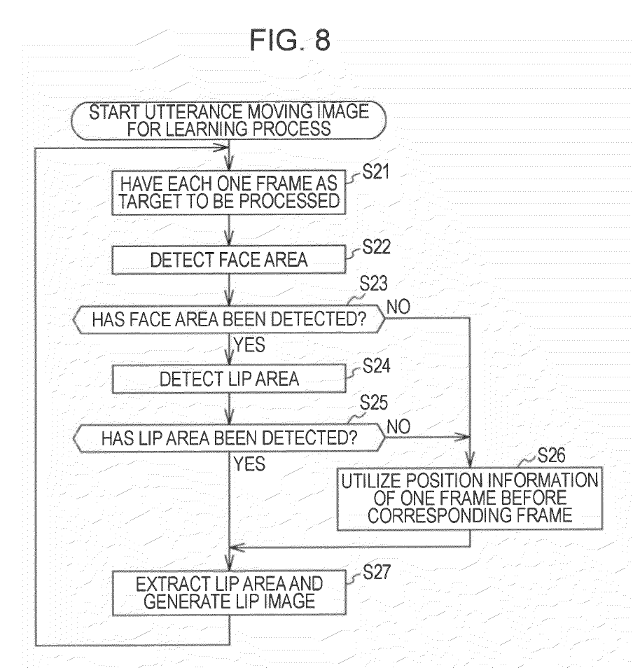

FIG. 8 is a flowchart explaining a process of the utterance moving image for learning in Step S12.

In Step S21, the face area detecting unit 22 splits the utterance moving image for learning into frames and has each one frame as a target for processing. The face area detecting unit 22 detects a face area from the frame as a target for processing in Step S22, and determines whether the face area has been detected or not in Step S23. When it is determined that the face area has been detected, the process advances to Step S24. On the contrary, when it is determined that the face area has not been detected, the process advances to Step S26.

In Step S24, the face area detecting unit 22 outputs position information of the face area to the lip area detecting unit 23 together with one frame portion of the utterance moving image for learning as a target for processing. The lip area detecting unit 23 detects the lip area from the face area of the frame as a target for processing, and determines whether the lip area has been detected or not in Step S25. When it is determined that the lip area has been detected, the process advances to Step S27. On the contrary, when the lip area has not been detected, the process advances to Step S26.

Furthermore, when the process advances to Step S26 from Step S23 or Step S25, position information of at least one of the face area or the lip area in one frame prior to the frame as a target for processing is utilized.

In Step S27, the lip area detecting unit 23 outputs the position information of the lip area to the lip image generating unit 24 together with one frame portion of the utterance moving image for [earning as a target for processing. The lip image generating unit 24 appropriately performs rotation correction for one frame of the utterance moving image for learning as a target for processing so that lines connecting the edge points of corners of the mouth at the lips are horizontal. Moreover, the lip image generating unit 24 extracts the lip area from each frame after the rotation correction, generates a lip image by resizing the extracted lip area to a predetermined image size, and outputs the image to the viseme label adding unit 28.

After that, the process returns to Step S21 and processes from Step S21 to Step S27 are repeated until the input of signals the utterance moving image for learning is finished.

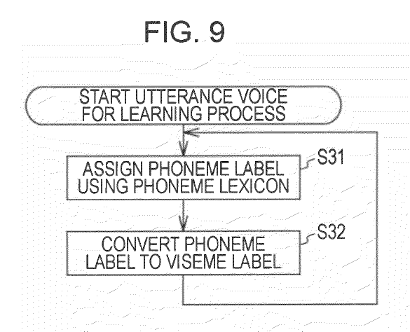

Next, FIG. 9 is a flowchart explaining the process of the utterance voice for learning in Step S13 in detail.

In Step S31, the phoneme label assigning unit 25 assigns a phoneme label indicating a phoneme to the utterance voice for learning by referring to the phoneme lexicon 26 and outputs the label to the viseme label converting unit 27.

In Step S32, the viseme label converting unit 27 converts the phoneme label assigned to the utterance voice for learning into a viseme label indicating the shape of the lip during uttering by using the conversion table that has been stored in advance and outputs the label to the viseme label adding unit 28.

After that, the process returns to Step S31, and processes from Step S31 to Step S32 are repeated until input of the utterance voice for learning is finished.

Returning to FIG. 7, in Step S14, the viseme label adding unit 28 utilizes and adds the viseme label assigned to the utterance voice for learning input from the viseme label converting unit 27 to the lip image corresponding to each frame of the utterance moving image for learning input from the lip image generating unit 24, and outputs the lip image added with the viseme label to the learning sample storing unit 29. The learning sample storing unit 29 stores the lip image with the viseme label as a learning sample. After the predetermined number M of learning samples are stored in the learning sample storing unit 29, the processes of Step S15 and thereafter are performed.

In Step S15, the viseme classifier learning unit 30 obtains an image feature amount of plural lip images as learning samples stored in the learning sample storing unit 29, learns a plurality of weak classifiers by the AdaBoost ECOC, and generates the viseme classifier 31 including the plurality of weak classifiers.

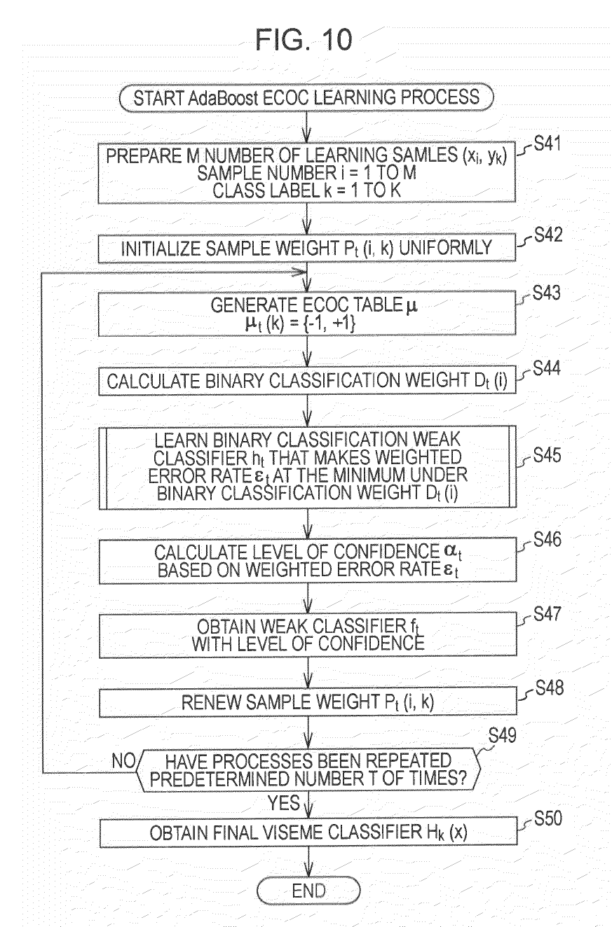

FIG. 10 is a flowchart explaining the process (AdaBoost ECOC learning process) of Step S15 in detail.

In Step S41, the viseme classifier learning unit 30 acquires the M number of learning samples (xi, yk) from the learning sample storing unit 29 as shown in FIG. 4.

In Step S42, the viseme classifier learning unit 30 initializes a sample weight Pt (i, k) represented by M-th row and K-th column according to the following formula (2). Specifically, as for the initial value P1 (i, k) of the sample weight Pt (i, k), one corresponding to an actual learning sample (xi, yk) is set to 0, and others are set to a uniform value that makes the sum thereof is 1.

P1(i, k)=1/M(K−1) for yk≠K (2)

Processes from Step S43 to Step S48 described below are repeated an arbitrary number T of times. Furthermore, the arbitrary repetition number T can be the maximum number of pixel difference features obtained on the lip image, and the same number of weak classifiers as the repetition number T is obtained.

In Step S43, the viseme classifier learning unit 30 generates an ECOC table in 1-st row and K-th column. Furthermore, the value μt(k) in k-th column of the ECOC table is −1 or +1, and values in the table are randomly allotted so that the number of −1 and the number of +1 are the same.

μt(k)={−1, +1} (3)

In Step S44, the viseme classifier learning unit 30 calculates a weight Dt(i) for binary classification represented by M-th row and 1-st column according to the following Formula (4). Furthermore, in the Formula (4), the formula in □ below is a logical expression and, 1 stands for true and 0 stands for false.

$$\begin{matrix}[ Expression 1 ] & \\ {D}_{t} ( i ) = \frac{{\sum }_{k}^{K} P ( i , k ) [ {μ}_{t} ( {y}_{i} ) \neq μ ( k ) ]}{{\sum }_{j}^{M} {\sum }_{k}^{K} P ( j , k ) [ {μ}_{t} ( {y}_{j} ) \neq μ ( k ) ]} & ( 4 )\end{matrix}$$

In Step S45, the viseme classifier learning unit 30 learns a binary classification weak classifier ht that has a weighted error rate εt shown in the following Formula (5) under the weight Dt(i) for binary classification obtained in Step S44.

$$\begin{matrix}[ Expression 2 ] & \\ {ɛ}_{t} = {\sum }_{i : {h}_{t} ( {x}_{i} ) \neq μ ( {y}_{i} )} {D}_{t} ( i ) & ( 5 )\end{matrix}$$

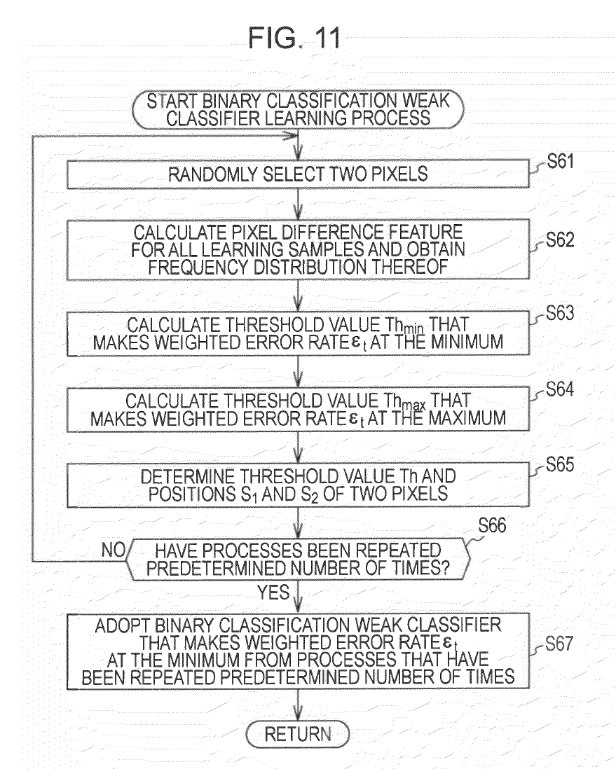

FIG. 11 is a flowchart explaining the process of Step S45 in detail.

In Step S61, the viseme classifier learning unit 30 randomly selects two pixels from the all pixels of the lip image. For example, when the lip image has 32×32 pixels, one pixel is selected from a set of 1024×1023 pixels for the selection of the two pixels. Here, the pixel positions of the two pixels are 51 and S2, and the pixel values (luminance value) are I1 and I2.

In Step S62, the viseme classifier learning unit 30 calculates a pixel difference feature (I1−I2) by using the pixel values I1 and I2 of the two pixels selected in Step S61 for all the learning samples and obtains the frequency distribution.

In Step S63, the viseme classifier learning unit 30 obtains a threshold value Thmin that makes the weighted error rate st shown in Formula (5) the minimum value εmin based on the frequency distribution of the pixel difference feature.

In Step S64, the viseme classifier learning unit 30 obtains a threshold value Thmax that makes the weighted error rate et shown in Formula (5) the maximum value max based on the frequency distribution of the pixel difference feature. Moreover, the viseme classifier learning unit 30 inverts the threshold value Thmax or the like according to following Formula (6).

ε′max=1−εmax

S′1=S2

S′2=S1

Th′max=−THmax (6)

In Step S65, the viseme classifier learning unit 30 determines the threshold value Th and the positions S1 and S2 of the two pixels that are parameters of the binary classification weak classifier based on the magnitude relation of the minimum value εmin and the maximum value εmax of the weighted error rate et described above.

In other words, when εmin<ε′max, the positions 51 and S2 of the two pixels and the threshold value Thmin are adopted as parameters. In addition, when εmine′max, the positions S′1 and S′2 of the two pixels and the threshold value Th′max are adopted as parameters.

In Step S66, the viseme classifier learning unit 30 determines whether the processes from Step S61 to Step S65 described above have been repeated a predetermined number of times, the process returns to Step S61 before the viseme classifier learning unit 30 determines that the processes have been repeated the predetermined number of times, and Step S61 and thereafter are repeated. In addition, when the viseme classifier learning unit 30 determines that the processes from Step S61 to Step S65 have been repeated the predetermined number of times, the process advances to Step S67.

In Step S67, the viseme classifier learning unit 30 finally adopts one that makes the weighted error rate εt the minimum value from among the (parameters of) binary classification weak classifiers determined in the process of Step S65 that have been repeated the predetermined number of times as described above, as one (parameter of) binary classification weak classifier ht.

As described above, after one binary classification weak classifier ht is determined, the process returns to Step S46 shown in FIG. 10.

In Step S46, the viseme classifier learning unit 30 calculates a level of confidence αt according to following Formula (7) based on the weighted error rate εt corresponding to the binary classification weak classifier ht determined in the process of Step S45.

[Expression 3]

αt=1/2ln(1−εt/εt) (7)

In Step S47, the viseme classifier learning unit 30 obtains a binary classification weak classifier ft(xi) with a level of confidence by multiplying the binary classification weak classifier ht determined in the process of Step S45 by the level of confidence αt calculated in the process of Step S46, as shown in following Formula (8).

ft(xi)=αt ht (8)

In Step S48, the viseme classifier learning unit 30 renews the sample weight Pt(i, k) represented by the M-th row and K-th column according to following Formula (9).

[Expression 4]

Pt+1(i,k)=Pt(i,k)exp(ft(xi)μt(k)−ft(xi)μt(yi)/2)/Zt (9)

Provided that, the Zi in Formula (9) is as shown in following Formula (10).

$$\begin{matrix}[ Expression 5 ] & \\ {Z}_{t} = {\sum }_{i}^{M} {\sum }_{k}^{K} {P}_{t} ( i , k ) exp ( \frac{{f}_{t} ( {x}_{i} ) {μ}_{t} ( k ) - {f}_{t} ( {x}_{i} ) {μ}_{t} ( {y}_{i} )}{2} ) & ( 10 )\end{matrix}$$

In Step S49, the viseme classifier learning unit 30 determines whether the processes from Step S43 to Step S48 described above have been repeated a predetermined number T of times, the process returns to Step S43 before the viseme classifier learning unit 30 determines that the processes have been repeated the predetermined number T of times, and Step S43 and thereafter are repeated. In addition, when the viseme classifier learning unit 30 determines that the processes from Step S43 to Step S48 have been repeated the predetermined number T of times, the process advances to Step S50.

In Step S50, the viseme classifier learning unit 30 obtains a final classifier Hk(x), that is, the viseme classifier 31 according to following Formula (11) based on the binary classification weak classifiers ft(x) with a level of confidence obtained in the same number as the predetermined number T and the ECOC tables corresponding to each of them.

$$\begin{matrix}[ Expression 6 ] & \\ {H}_{k} ( x ) = {\sum }_{t = 1}^{T} {f}_{t} ( x ) {μ}_{t} ( k ) & ( 11 )\end{matrix}$$

Furthermore, the obtained viseme classifier 31 has the number of classes (number of visemes) K and the number T of weak classifiers as parameters. In addition, as parameters of each of the weak classifiers, the viseme classifier 31 has the positions S1 and S2 of the two pixels on the lip image, the threshold value Th for discriminating the pixel difference feature, the level of confidence α, and the ECOC table μ.

As described above the AdaBoost ECOC learning process ends after the final classifier Hk(x), that is, the viseme classifier 31 is obtained.

According to the viseme classifier 31 produced as above, the input image feature amount of the lip image can be expressed with a K-dimensional score vector. In other words, it is possible to express through quantification the degree of similarity of the lip image produced from each frame of the utterance moving image for registration to each of K (19 in this case) kinds of visemes. In addition, in the same manner, it is possible to express through quantification the degree of similarity of the lip image produced from each frame of the utterance moving image for recognition to each of K kinds of visemes.

### Details of Registration Process

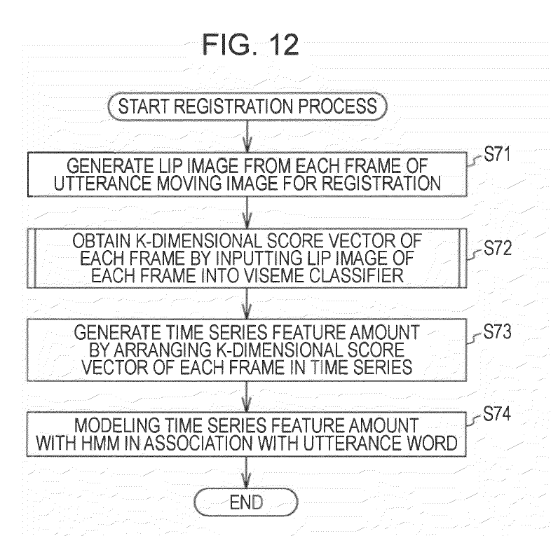

FIG. 12 is a flowchart explaining the registration process of Step S2 in detail.

In Step S71, the registration system 12 generates lip images corresponding to each frame of the utterance moving image for registration by executing the same process as that of the utterance moving image for learning by the learning system 11 described with reference to FIG. 7. The produced lip images are input to the viseme classifier 31 and the utterance period detecting unit 44.

In Step S72, the utterance period detecting unit 44 specifies an utterance period based on the lip images of each frame of the utterance moving image for registration, and informs the viseme classifier 31 and the time series feature amount generating unit 45 of whether the lip images of each frame correspond to the utterance period. The viseme classifier 31 calculates a K-dimensional score vector corresponding to a lip image for the utterance period among lip images input in order.

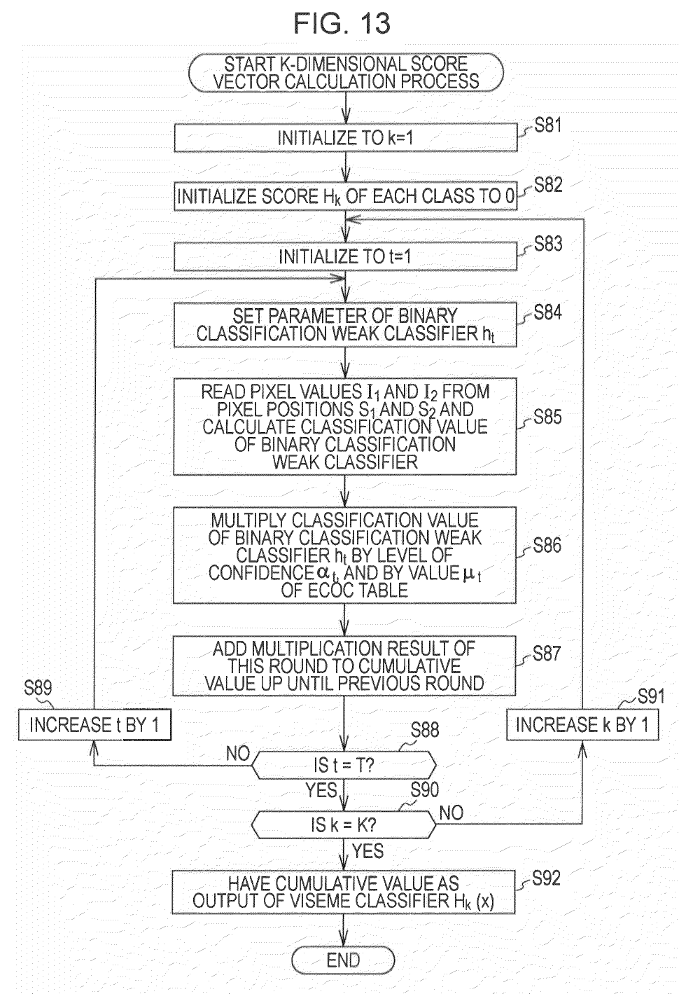

FIG. 13 is a flowchart explaining the K-dimensional score vector calculation process by the viseme classifier 31 in detail.

In Step S81, the viseme classifier 31 initializes a parameter k (k=1, 2, . . . , K) indicating a class to 1. In Step S82, the viseme classifier 31 initializes a score Hk of each class to 0.

In Step S83, the viseme classifier 31 initializes a parameter t (t=1, 2, . . . , T) for specifying a weak classifier to 1.

In Step S84, the viseme classifier 31 sets parameters of a binary classification weak classifier ht, which are positions S1 and S2 of two pixels on a lip image x, a threshold value Th for discriminating a pixel difference feature, a level of confidence α, and an ECOC table μ.

In Step S85, the viseme classifier 31 reads the pixel values I1 and I2 from the positions S1 and S2 of the two pixels on the lip image x, and obtains the classification value (−1 or +1) of the binary classification weak classifier ht by calculating the pixel difference feature (I1 and I2) and comparing the result and the threshold value Th.

In Step S86, the viseme classifier 31 obtains a class score Hk in 1-st row and K-th column corresponding to the parameter t by multiplying the classification value of the binary classification weak classifier ht obtained in Step S85 by the level of confidence αt, and further by a value μt(k) of the ECOC table in 1-st row and K-th column.

In Step S87, the viseme classifier 31 renews the class score Hk in the 1-st row and the K-th column that has been obtained in Step S86 and corresponds to the parameter t by adding the cumulative value of the class score Hk in the 1-st row and the K-th column until the previous round (that is, t−1).

In Step S88, the viseme classifier 31 determines whether the parameter t=T or not, and when the viseme classifier 31 determines that the parameter t≠T, the process advances to Step S89 to increase the parameter t by 1. Then, the process returns to Step S84 to repeat Step S84 and thereafter. After that, when it is determined that the parameter t=T in Step S88, the process advances to Step S90.

In Step S90, the viseme classifier 31 determines whether the parameter k=K or not, and when the viseme classifier 31 determines that the parameter k≠K, the process advances to Step S91 to increase the parameter k by 1. Then, the process returns to Step S83 to repeat Step S83 and thereafter. After that, when it is determined that the parameter k=K in Step S90, the process advances to Step S92.

In Step S92, the viseme classifier 31 has the class score Hk in the 1-st row and the K-th column obtained at that point as the output of the viseme classifier 31, in other words, outputs the class score Hk to the next stage (the time series feature amount generating unit 45 in this case) as the K-dimensional score vector. With the above process, the K-dimensional score vector calculation process ends.

Returning to FIG. 12, in Step S73, the time series feature amount generating unit 45 generates a time series feature amount corresponding to the utterance period of the utterance moving image for registration by arranging the K-dimensional score vector input in order from the viseme classifier 31 in a time series for the utterance period informed from the utterance period detecting unit 44.

In Step S74, the time series feature amount learning unit 46 performs modeling for the time series feature amount input from the time series feature amount generating unit 45 with HMM in association with the utterance word for registration (utterance content of the speaker in the utterance moving image for registration) supplied from outside together with the utterance moving image for registration. The modeled time series feature amount is stored in the learning database 48 built in the utterance recognizer 47. With the above process, the registration process ends.

### Detail of Recognition Process

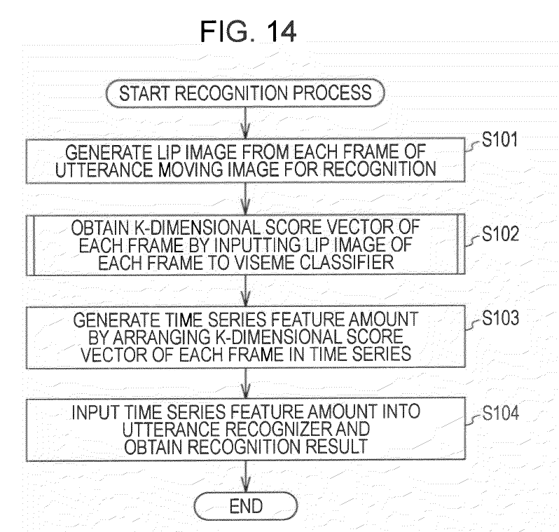

FIG. 14 is a flowchart explaining the recognition process in detail.

The recognition system 13 performs the same processes as those from Step S71 to Step S73 of the registration process by the registration system 12 described above with reference to FIG. 12, as processes from Step S101 to Step S103 for the input utterance moving image for recognition. As a result, a time series feature amount corresponding to the utterance period of the utterance moving image for recognition is generated. The generated time series feature amount corresponding to the utterance period of the utterance moving image for recognition is input to the utterance recognizer 47.

In Step S104, the utterance recognizer 47 specifies the most similar model among those stored in the learning database 48 to the time series feature amount input from the time series feature amount generating unit 45. Moreover, the utterance recognizer 47 outputs the utterance words for registration in association with the specified model as an utterance recognition result corresponding to the utterance moving image for recognition. With the process above, the recognition process ends.

### Result of Recognition Experiment

Next, the result of the recognition experiment by the utterance recognition device 10 will be described.

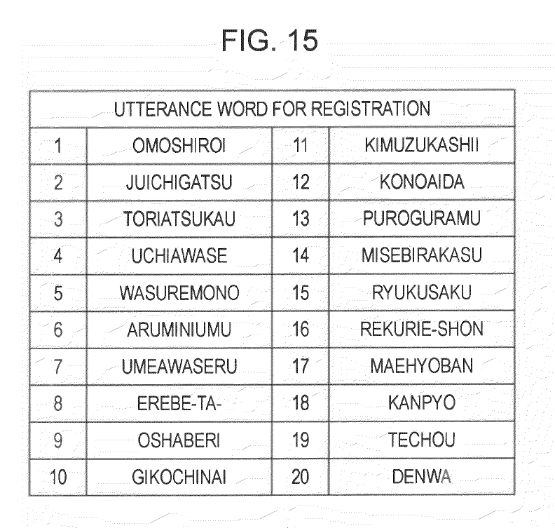

In this recognition experiment, an utterance moving image with voice for learning was used that had been produced by video-capturing 73 individual test subjects (speakers) who uttered 216 words for a learning process. In addition, 20 words shown in FIG. 15 out of the 216 words uttered during the learning process were selected as utterance words for registration for a registration process, and an utterance moving image for learning corresponding to the 20 words was utilized as an utterance moving image for registration. Furthermore, in modeling using the HMM, a transition probability was restricted to left-to-right, and transition models of 40 states were adopted.

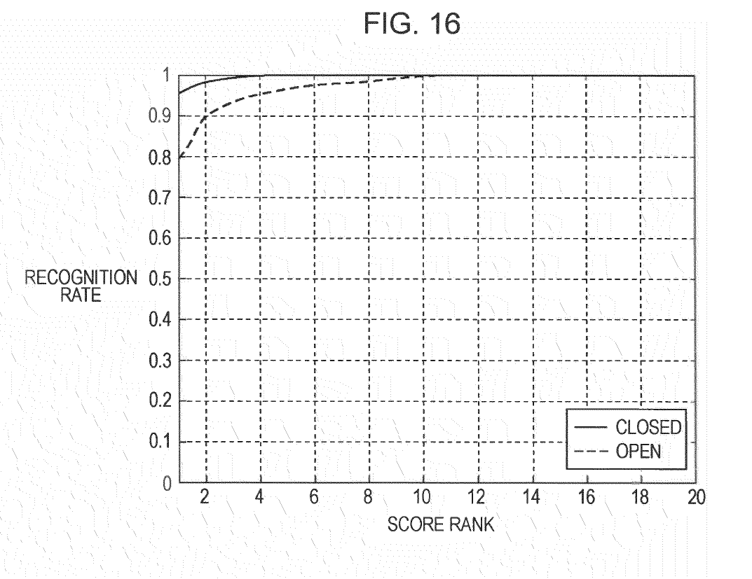

Furthermore, in a recognition process, a closed evaluation that used the utterance moving image for recognition of the same test subjects as those in the learning process and the registration process and an open evaluation that used the utterance moving image for recognition of different test subjects from those in the learning process and the registration process were performed, and thereby to obtain recognition rates shown in FIG. 16.

FIG. 16 shows probabilities (the vertical axis) that a correct interpretation (an HMM corresponding to an utterance word for registration W) belongs to the M-th order (the horizontal axis) when time series feature amounts corresponding to an utterance moving image for recognition in which the utterance word for registration W is spoken are ranked according to the degree of similarity to each HMM corresponding to each of 20 kinds of utterance words for registration.

According to the same drawing, a recognition rate of 96% could be obtained in case of the closed evaluation. In addition, a recognition rate of 80% could be obtained in case of the open evaluation.

Furthermore, in the recognition experiment described above, the test subjects (speakers) were the same in the learning process and the registration process and the utterance moving image for learning was utilized as the utterance moving image for registration. However, test subjects (speakers) may be different in the leaning process and the registration process, and moreover, test subjects (speakers) may again be different in the recognition process.

According to the utterance recognition device 10 as the first embodiment described above, since a classifier for calculating a feature amount of an input image (a lip image in this case) is generated by learning, it is not necessary to newly design a classifier for a target to be recognized in every case. Therefore, by changing the kind of labels, the present invention can be applied to, for example, a recognition device for identifying gestures or handwriting from a moving image.

In addition, it is possible to extract a feature amount with generality for an image containing portions showing significant individual difference by the learning process.

Furthermore, it is possible to perform a real-time recognition process because a pixel difference with relatively small calculation amount is used in an image feature amount.

### 2. Second Embodiment

### Example of Composition of Digital Still Camera

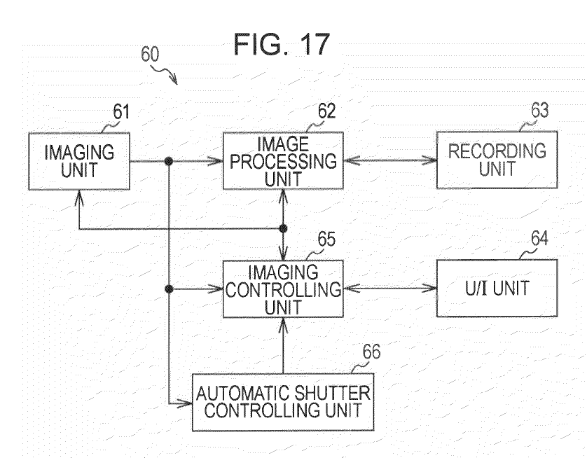

Next, FIG. 17 shows an example of the composition of a digital still camera 60 as a second embodiment. The digital still camera 60 has an automatic shutter function to which the lip-reading technique is applied. Specifically, when it is detected that a person as a subject utters a predetermined keyword (hereinafter, referred to as a shutter keyword) such as “Ok, cheese” or the like, the camera is supposed to press the shutter (imaging a still image) according to the utterance.

The digital still camera 60 includes an imaging unit 61, an image processing unit 62, a recording unit 63, a U/I unit 64, an imaging controlling unit 65 and an automatic shutter controlling unit 66.

The imaging unit 61 includes a lens group and imaging device such as complementary metal-oxide semiconductor (CMOS) (any of them are not shown in the drawing) or the like, acquires an optical image of a subject to convert into an electric signal, and outputs an image signal obtained from the result to the next stage.

In other words, the imaging unit 61 outputs the image signal to the imaging controlling unit 65 and the automatic shutter controlling unit 66 in the pre-imaging stage according to the control of the imaging controlling unit 65. In addition, the imaging unit 61 performs imaging according to the control of the imaging controlling unit 65 and outputs the image signal obtained from the result to the image processing unit 62.

Hereinafter, a moving image that is displayed on a display (now shown in the drawing) included in the U/I unit 64 and is output to the imaging controlling unit 65 for determining a composition before imaging is called a finder image. The finder image is also output to the automatic shutter controlling unit 66. In addition, an image signal output from the imaging unit 61 to the image processing unit 62 as a result of the imaging is called a recording image.

The image processing unit 62 performs a predetermined image processing (for example, image stabilization correction, white balance correction, pixel interpolation, or the like) to the recording image input from the imaging unit 61, then encodes the processed image with a predetermined encoding mode, and outputs an image-encoded data obtained from the result to the recording unit 63. In addition, the image processing unit 62 decodes the image-encoded data input from the recording unit 63 and outputs an image signal obtained from the result (hereinafter, referred to as a playback image) to the imaging controlling unit 65.

The recording unit 63 records the image-encoded data input from the image processing unit 62 in a recording medium not shown in the drawing. In addition, the recording unit 63 reads the image-encoded data recorded in the recording medium and outputs to the image processing unit 62.

The imaging controlling unit 65 controls the entire digital still camera 60. Particularly, the imaging controlling unit 65 controls the imaging unit 61 to execute imaging according to a shutter operation signal from the U/I unit 64, or an automatic shutter signal from the automatic shutter controlling unit 66.

The U/I (user interface) unit 64 includes various input devices represented by a shutter button that receives shutter operation by a user and a display that displays the finder image, the playback image, or the like. Particularly, the U/I unit 64 outputs a shutter operation signal to the imaging controlling unit 65 according to the shutter operation from the user.

The automatic shutter controlling unit 66 outputs the automatic shutter signal to the imaging controlling unit 65 based on the finder image input from the imaging unit 61 when it is detected that a shutter keyword by a person who is a subject is uttered.

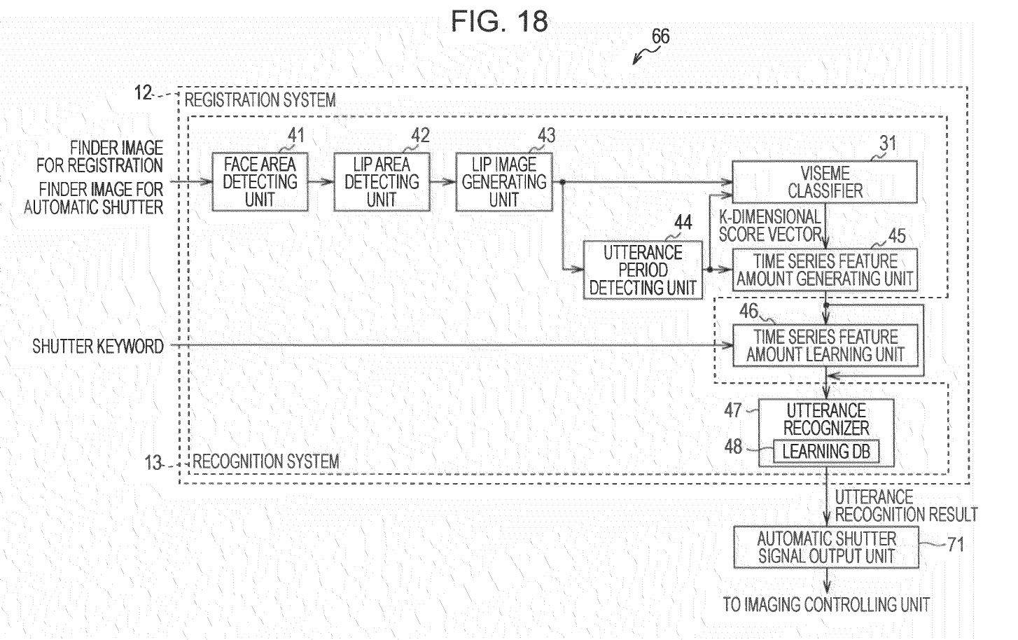

Next, FIG. 18 shows an example of the composition of the automatic shutter controlling unit 66 in detail.

As clear from the comparison between the drawing and FIG. 1, the automatic shutter controlling unit 66 includes an automatic shutter signal output unit 71 in addition to the same composition as that including the registration system 12 and the recognition system 13 of the utterance recognition device 10 of FIG. 1. Since the common constituent components of the automatic shutter controlling unit 66 with those of the utterance recognition device 10 of FIG. 1 are given with the same reference numerals, description thereof will not be repeated.

However, the viseme classifier 31 in the automatic shutter controlling unit 66 has been already learned.

The automatic shutter signal output unit 71 generates an automatic shutter signal to output to the imaging controlling unit 65 when it is found that the utterance recognition result from the utterance recognizer 47 is a shutter keyword that has been registered.

### Description of Performance

Next, the performance of the digital still camera 60 will be described. The performance of the digital still camera 60 is provided with a normal imaging mode, a normal playback mode, a shutter keyword registration mode, an automatic shutter execution mode, or the like.

In the normal imaging mode, imaging is performed according to shutter operation by a user. In the normal playback mode, an image that has been imaged is played back and displayed according to playback operation by the user.

In the shutter keyword registration mode, an HMM of a time series feature amount indicating a movement of the lip of a subject (the user or the like) who utters an arbitrary word as a shutter keyword is registered. In addition, it may be possible to register in advance a shutter keyword and an HMM of a time series feature amount indicating a movement of the lip corresponding thereto in a stage where the digital still camera 60 is on the market as product.

In the automatic shutter execution mode, a time series feature amount indicating a movement of the lip of a person as a subject is detected based on a finder image, and imaging is performed when a shutter keyword is recognized to be uttered based on the detected time series feature amount.

### Details of Shutter Keyword Registration Process

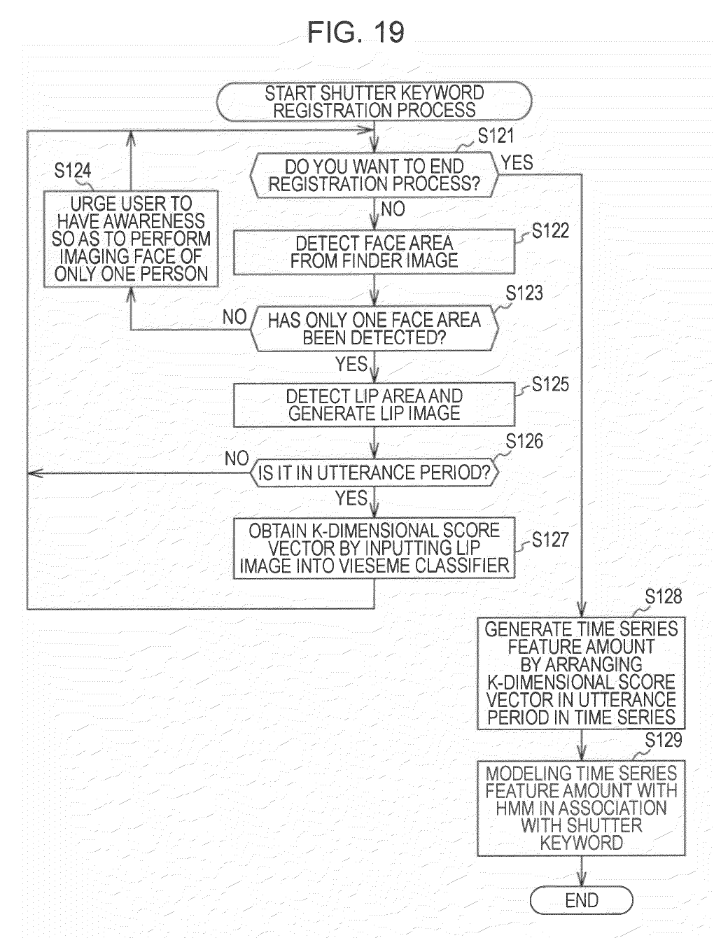

Next, FIG. 19 is a flowchart explaining the shutter keyword registration process.

This shutter keyword registration process starts when the shutter keyword registration mode is turned on according to predetermined operation from a user, and ends when the shutter keyword registration mode is turned off according to predetermined operation from the user.

Furthermore, after the user instructs the start of the shutter keyword registration process, the user makes the face of a speaker who utters a word desired to be registered as a shutter keyword appear on a finder image. It is preferable that a person who is a subject during the automatic shutter execution process is to be used as the speaker, but it may be possible to use another person, for example, the user itself as the speaker. In addition, after the utterance of the shutter keyword is ended, the user instructs the end of the shutter keyword registration process.

In Step S121, the imaging controlling unit 65 determines whether the end of the shutter keyword registration process has been instructed or not, and when it has not been instructed, the process advances to Step S122.

In Step S122, the face area detecting unit 41 of the registration system 12 splits the finder image into frames, and has each one of the frames as a target to be processed. A face area is detected from each of the frames as a target to be processed. In Step S123, the face area detecting unit 41 determines whether only one face area has been detected from the frames as targets to be processed, and when a plurality of face areas has been detected or when any one of the face area has not been detected, the process advances to Step S124.

In Step S124, the U/I unit 64 urges the user to have awareness to make only one speaker uttering a word desired to be registered as a shutter keyword appear on the finder image. After that, the process returns to Step S121, and Step S121 and thereafter are repeated.

In Step S123, when only one face area has been detected from the frames as targets to be processed, the process advances to Step S125.

In Step S125, the face area detecting unit 41 outputs the finder image of one frame portion as a target to be processed and the position information of the face area to the lip area detecting unit 42. The lip area detecting unit 42 detects the lip area from the face area in the frame as a target to be processed, and outputs the finder image of one frame portion as a target to be processed and the position information of the lip area to the lip image generating unit 43.

The image generating unit 43 appropriately performs rotation correction for one frame of the finder image as a target to be processed so that lines connecting edge points of the corners of the mouth at the lips are horizontal. Furthermore, the lip image generating unit 43 extracts the lip area from each frame that has been subjected to the rotation correction, and produces a lip image by resizing the extracted lip area to an image size that has been determined. The generated lip image is input to the viseme classifier 31 and the utterance period detecting unit 44.

In Step S126, the utterance period detecting unit 44 determines whether a frame is in the utterance period or not based on the lip image of the frame as a target to be processed, and informs the determination result to the viseme classifier 31 and the time series feature amount generating unit 45. In addition, when the frame is in the utterance period, the process advances to Step S127. On the contrary, when the frame is not in the utterance period, Step S127 is skipped.

In Step S127, the viseme classifier 31 calculates a K-dimensional score vector corresponding to a lip image for the utterance period among lip images input in order and outputs the value to the time series feature amount generating unit 45. After that, the process returns to Step S121 and processes from Step S121 to Step S127 are repeated until the shutter keyword registration process ends.

In addition, when it is determined that the end of the shutter keyword registration process has been instructed in Step S121, the process advances to Step S128.

In Step S128, the time series feature amount generating unit 45 generates a time series feature amount corresponding to the registered shutter keyword by arranging the K-dimensional score vector in the time series input from the viseme classifier 31 in order during the utterance period informed from the utterance period detecting unit 44.

In Step S129, the time series feature amount learning unit 46 performs modeling for the time series feature amount input from the time series feature amount generating unit 45 with the HMM in association with text data of the shutter keyword input from the U/I unit 64. The modeled time series feature amount is stored in the learning database 48 provided in the utterance recognizer 47. With the process above, the shutter keyword registration process ends.

### Details of Automatic Shutter Execution Process

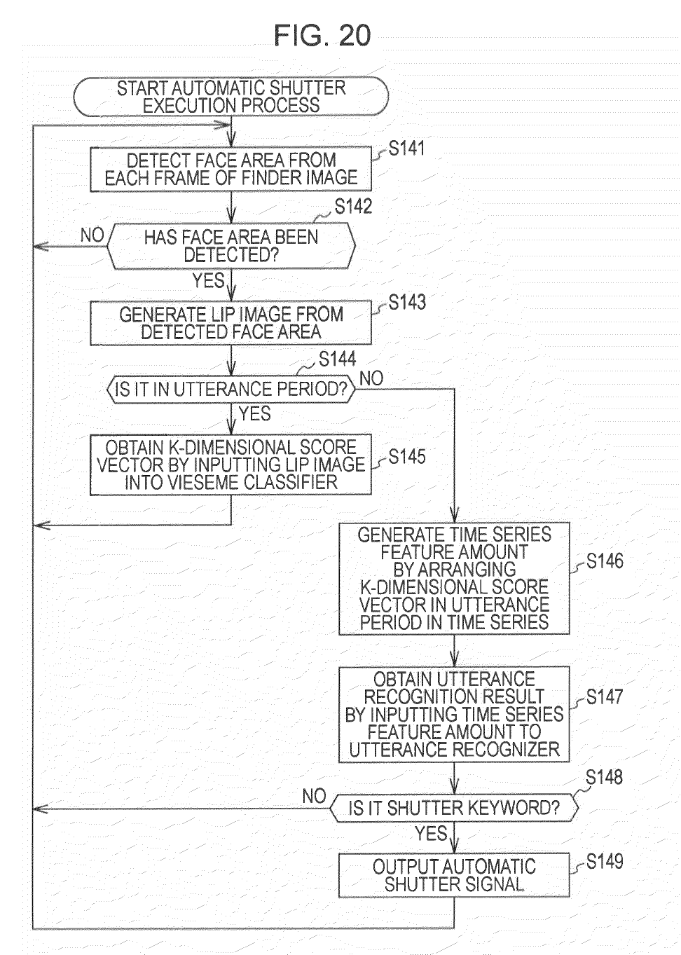

Next, FIG. 20 is a flowchart explaining the automatic shutter execution process.

This automatic shutter execution process starts when an automatic shutter execution mode is turned on according to predetermined operation from the user, and ends when the automatic shutter execution mode is turned off according to predetermined operation from the user.

In Step S141, the face area detecting unit 41 of the recognition system 12 splits the finder image into frames, and has each one frame as a target to be processed. A face area is detected from each of the frames as a target to be processed.

In Step S142, the face area detecting unit 41 determines whether the face area has been detected from the frame as a target to be processed, and the process returns to Step S141 until the face area is detected. In addition, when the face area has been detected from the frame as a target to be processed, the process advances to Step S143.

Furthermore, it does not matter that a plurality of face areas is detected from one frame here, different from the case during the shutter keyword registration process. When a plurality of face areas is detected from one frame, the process and the ones thereafter are executed for all of the detected face areas.

In Step S143, the face area detecting unit 41 outputs the finder image of one frame portion as a target to be processed and the position information of the face area to the lip area detecting unit 42. The lip area detecting unit 42 detects the lip area from the face area in the frame as a target to be processed, and outputs the finder image of one frame portion as a target to be processed and the position information of the lip area to the lip image generating unit 43.

The lip image generating unit 43 appropriately performs rotation correction for one frame of the finder image as a target to be processed so that lines connecting edge points of the corners of the mouth at the lips are horizontal. Furthermore, the lip image generating unit 43 extracts the lip area from each of the frames that has been subjected to the rotation correction, and produces a lip image by resizing the extracted lip area to an image size that has been determined. The generate lip image is input to the viseme classifier 31 and the utterance period detecting unit 44.

In Step S144, the utterance period detecting unit 44 determines an utterance period based on the lip image of the frame as a target to be processed. In other words, when it is determined that the frame as a target to be processed is at the starting point of the utterance period or in the utterance period, the process advances to Step S145.

In Step S145, the viseme classifier 31 calculates a K-dimensional score vector corresponding to a lip image for the utterance period among lip images input in order to output to the time series feature amount generating unit 45. After that, the process returns to Step S141, and Step S141 and thereafter are repeated.

In Step S144, when it is determined that the frame as a target to be processed is the ending point of the utterance period, the process advances to Step S146.

In Step S146, the time series feature amount generating unit 45 generates a time series feature amount corresponding to the movement of the lip of the subject by arranging the K-dimensional score vector input from the viseme classifier 31 in order in the time series during the utterance period informed from the utterance period detecting unit 44.

In Step S147, the time series feature amount generating unit 45 inputs the generated time series feature amount to the utterance recognizer 47. In Step S148, the utterance recognizer 47 determines whether the movement of the lip of the subject corresponds to the shutter keyword or not by comparing the time series feature amount input from the time series feature amount generating unit 45 and the HMM corresponding to the shutter keyword stored in the learning database 48. When it is determined that the movement of the lip of the subject corresponds to the shutter keyword, the process advances to Step S149. Furthermore, when it is determined that movement of the lip of the subject does not correspond to the shutter keyword, the process returns to Step S141, and Step S141 and thereafter are repeated.

In Step S149, the utterance recognizer 47 informs the automatic shutter signal output unit 71 that the movement of the lip of the subject corresponds to the shutter keyword. The automatic shutter signal output unit 71 generates an automatic shutter signal according to the information and outputs the signal to the imaging controlling unit 65. The imaging controlling unit 65 performs imaging by controlling the imaging unit 61 or the like according to the automatic shutter signal. Furthermore, the timing of the imaging is arbitrarily set by the user such as after a predetermined time (for example, for one second) after the utterance of a shutter keyword or the like. After that, the process returns to Step S141 and Step S141 and thereafter are repeated.

Furthermore, in the description above, when a plurality of face areas (of subjects) is detected from the finder image, it is possible that anyone among a plurality of subjects utters a shutter keyword.

However, it may be possible to perform imaging by changing such a condition, for example, imaging a majority of subjects uttering the shutter keyword. With the condition, it is possible to give users pleasure of imaging group photos. In addition, since recognition of a plurality of faces is performed, the recognition result is solid, and thereby, it is possible to expect an effect suppressing erroneous detection of shutter keywords or the like.

Furthermore, it may be possible to detect a shutter keyword by focusing only on a specific person among a plurality of subjects, by combining a person identification technology that enables the identification of the face of an individual. The specific person may be plural. If the shutter keyword registration process described above is performed having the specific person as a test subject (subject), it is possible to achieve more reliable and accurate utterance recognition.

As described above, according to the digital still camera 60 of the second embodiment, a subject positioning in the distance can instruct imaging timing by simply uttering a shutter keyword in a noisy environment, without using a remote controller or the like. Furthermore, the shutter keyword can be arbitrarily set.

Furthermore, the present invention can be applied to digital video cameras, not being limited to digital still cameras.

A series of processes described above can be executed by hardware and by software. When the series of processes are executed by software, a program composing the software is installed from a program recording medium in a computer incorporated with a dedicated hardware, or for example, in a general personal computer or the like that can execute various function by installing various programs.

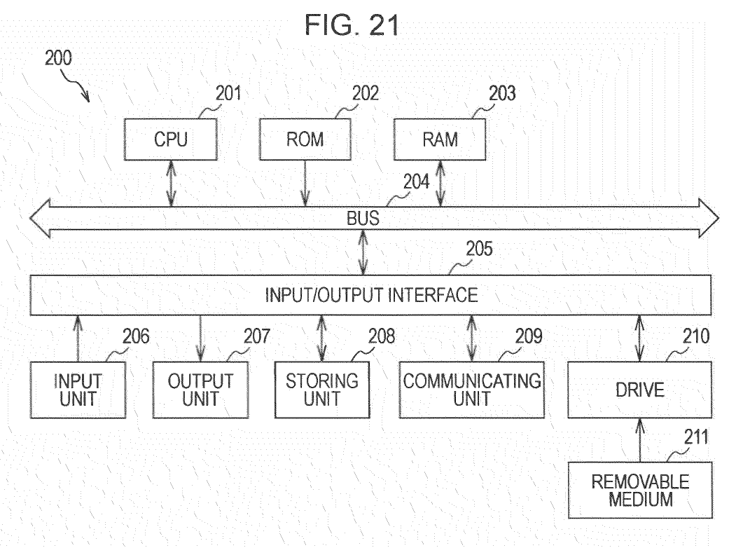

FIG. 21 is a block diagram illustrating an example of the composition of hardware of a computer executing a series of processes described above by a program.

In this computer 200, a central processing unit (CPU) 201, a read only memory (ROM) 202, and a random access memory (RAM) 203 are connected to one another via a bus 204.

The bus 204 is further connected to an input/output interface 205. The input/output interface 205 is connected to an input unit 206 including a keyboard, a mouse, a microphone or the like, an output unit 207 including a display, a speaker, or the like, a storing unit 208 including hard disk, a nonvolatile memory, or the like, a communicating unit 209 including a network interface or the like, and a drive 210 for driving a removable medium 211 such as a magnetic disc, an optical disc, a magneto optical disc, a semiconductor memory, or the like.

The computer composed as described above performs a series of processes mentioned above by causing the CPU 201 to, for example, load a program stored in the storing unit 208 in the RAM 203 via the input/output interface 205 and the bus 204 and execute the program.

The program executed by the computer (CPU 201) is recorded on the removable medium 211 which is a package medium including, for example, a magnetic disc (including a flexible disc), an optical disc (compact disc-read only memory (CD-ROM), digital versatile disc (DVD), or the like), a magneto optic disc, a semiconductor memory, or the like, or provided through a wired or wireless transmitting medium such as a local area network, the Internet, or digital satellite broadcasting.

In addition, the program can be installed in the storing unit 208 via the input/output interface 205 by loading the removable medium 211 on the drive 210. Furthermore, the program can be received with the communicating unit 209 via a wired or wireless transmitting medium and installed in the storing unit 208. In addition to that, the program can be installed in advance in the ROM 202 or the storing unit 208.

Moreover, the programs executed by the computer may be a program in which processing is performed in a time series following the order described in the present specification, and/or, may be a program in which processing is performed at a necessary timing such as when a call-out is received.

In addition, the program may be processed by one computer, and by a plurality of computers in a dispersed manner. Furthermore, the program may be executed by being transferred to a computer in a remote place.

The present application contains subject matter related to that disclosed in Japanese Priority Patent Application JP 2009-154923 filed in the Japanese Patent Office on Jun. 30, 2009 and Japanese Priority Patent Application JP 2009-154924 filed in the Japan Patent Office on Jun. 30, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an image acquisition unit configured to acquire a temporal sequence of frames of image data;
a detecting unit configured to detect a lip area and a lip image from each of the frames of the image data;
a recognition unit configured to recognize a word based on the detected lip images of the lip areas; and
a controller configured to control an operation at the information processing apparatus based on the word recognized by the recognition unit.

2. The information processing apparatus according to claim 1, wherein the image processing apparatus is a digital still camera, and the image acquisition unit is an imaging device of the digital still camera.

3. The information processing apparatus according to claim 2, wherein the controller is configured to command the imaging device of the digital still camera to capture a still image when the recognition unit recognizes a predetermined word.

4. The information processing apparatus according to claim 1, further comprising:
a face area detecting unit configured to detect a plurality of faces in the sequence of frames of image data, wherein
the recognition unit is configured to recognize a particular face from among a plurality of faces based on stored facial recognition data, and recognize a word based on the detected lip images of lip areas of the particular face.

5. The information processing apparatus according to claim 1, further comprising:
a face area detecting unit configured to detect a plurality of faces in the sequence of frames of image data, wherein
the recognition unit is configured to recognize a word based on the detected lip images of lip areas of any one of the plurality of faces.

6. The information processing apparatus according to claim 1, further comprising:
a face area detecting unit configured to detect a plurality of faces in the sequence of frames of image data, wherein
the recognition unit is configured to recognize a word based on the detected lip images of lip areas of a subset of the plurality of faces.

7. The information processing apparatus according to claim 1, further comprising:
a registration unit configured to register a word that causes the controller to control an operation of the information processing apparatus when the word is recognized by the recognition unit.

8. The information processing apparatus according to claim 1, further comprising:
a memory configured to store a plurality of visemes, each associated with a particular phoneme, wherein the recognition unit is configured to recognize a word by comparing the detected lip images of the lip areas to the plurality of visemes stored in the memory.

9. The information processing apparatus according to claim 1, further comprising:
an image separating unit configured to receive an utterance moving image with voice, separate the utterance moving image with voice into an utterance moving image and an utterance voice, and output the utterance moving image and the utterance voice;
a face area detecting unit configured to receive the utterance moving image from the image separating unit, split the utterance moving image into frames, detect a face area from each of the frames, and output position information of the detected face area together with one frame of the utterance moving image;
a lip area detecting unit configured to receive the position information of the detected face area together with the one frame of the utterance moving image from the face area detecting unit, detect a lip area from the face area of the one frame, and output the position information of the lip area together with the one frame of the utterance moving image;
a lip image generating unit configured to receive the position information of the lip area from the lip area detecting unit together with the one frame of the utterance moving image, perform rotation correction for the one frame of the utterance moving image, generate a lip image, and output the lip image to a viseme label adding unit;
a phoneme label assigning unit configured to receive the utterance voice from the image separating unit, assign a phoneme label indicating a phoneme to the utterance voice, and output the label;
a viseme label converting unit configured to receive the label from the phoneme label assigning unit, convert the phoneme label assigned to the utterance voice for learning into a viseme label indicating the shape of the lip during uttering, and output the viseme label;
a viseme label adding unit configured to receive the lip image output from the lip image generating unit and the viseme label output from the viseme label converting unit, add the viseme label to the lip image, and output the lip image added with the viseme label;
a learning sample storing unit configured to receive and store the lip image added with the viseme label from the viseme label adding unit, wherein
the recognition unit is configured to recognize a word by comparing the detected position of the lip areas from each of the frames of the image data to the data stored by the learning sample storing unit.

10. A non-transitory computer-readable medium including computer program instructions, which when executed by an information processing apparatus, cause the information processing apparatus to perform a method comprising:
acquiring a temporal sequence of frames of image data;
detecting a lip area and a lip image from each of the frames of the image data;
recognizing a word based on the detected lip images of the lip areas; and
controlling an operation at the information processing apparatus based on the recognized word.

11. The non-transitory computer-readable medium according to claim 10, wherein the image processing apparatus is a digital still camera, and the temporal sequence of frames of image data are acquired by an imaging device of the digital still camera.

12. The non-transitory computer-readable medium according to claim 11, further comprising:
controlling the imaging device of the digital still camera to capture a still image when a predetermined word is recognized.

13. The non-transitory computer-readable medium according to claim 10, further comprising:
detecting a plurality of faces in the sequence of frames of image data;
recognizing a particular face from among the plurality of faces based on stored facial recognition data; and
recognizing a word based on the detected lip images of lip areas of the particular face.

14. The non-transitory computer-readable medium according to claim 10, further comprising:
detecting a plurality of faces in the sequence of frames of image data; and
recognizing a word based on the detected lip images of lip areas of any one of the plurality of faces.

15. The non-transitory computer-readable medium according to claim 10, further comprising:
detecting a plurality of faces in the sequence of frames of image data; and
recognizing a word based on the detected lip images of lip areas of a subset of the plurality of faces.

16. The non-transitory computer-readable medium according to claim 10, further comprising:
registering a word causing the controller to control an operation of the information processing apparatus when the word is recognized.

17. The non-transitory computer-readable medium according to claim 10, further comprising:
storing a plurality of visemes, each associated with a particular phoneme, wherein the recognizing includes recognizing a word by comparing the detected lip images of the lip areas to plurality of visemes stored in the memory.

18. The non-transitory computer-readable medium according to claim 10, further comprising:
at an image separating unit of the information processing apparatus
receiving an utterance moving image with voice;
separating the utterance moving image with voice into an utterance moving image and an utterance voice; and
outputting the utterance moving image and the utterance voice, at a face area detecting unit of the information processing apparatus
receiving the utterance moving image from the image separating unit;
splitting the utterance moving image into frames;
detecting a face area from each of the frames; and
outputting position information of the detected face area together with one frame of the utterance moving image,
at a lip area detecting unit of the information processing apparatus
receiving the position information of the detected face area together with the one frame of the utterance moving image from the face area detecting unit;
detecting a lip area from the face area of the one frame; and
outputting the position information of the lip area together with the one frame of the utterance moving image,
at a lip image generating unit of the information processing apparatus
receiving the position information of the lip area from the lip area detecting unit together with the one frame of the utterance moving image;
performing rotation correction for the one frame of the utterance moving image;
generating a lip image; and
outputting the lip image to a viseme label adding unit,
at a phoneme label assigning unit of the information processing apparatus
receiving the utterance voice from the image separating unit;
assigning a phoneme label indicating a phoneme to the utterance voice; and
outputting the label,
at a viseme label converting unit of the information processing apparatus
receiving the label from the phoneme label assigning unit;
converting the phoneme label assigned to the utterance voice for learning into a viseme label indicating the shape of the lip during uttering; and
outputting the viseme label,
at a viseme label adding unit of the information processing apparatus
receiving the lip image output from the lip image generating unit and the viseme label output from the viseme label converting unit;
adding the viseme label to the lip image; and
outputting the lip image added with the viseme label,
at a learning sample storing unit of the information processing apparatus
receiving and storing the lip image added with the viseme label from the viseme label adding unit, wherein
the recognizing recognizes a word by comparing the detected position of the lip areas from each of the frames of the image data to the data stored by the learning sample storing unit.

19. An information processing apparatus comprising:
means for acquiring a temporal sequence of frames of image data;
means for detecting a lip area and a lip image from each of the frames of the image data;
means for recognizing a word based on the detected position of the lip images of the lip areas; and
means for controlling an operation at the information processing apparatus based on the word recognized by the means for recognizing.
